(19) United States
(12) Patent Application Publication
(10) Pub. No.: US 2026/0292624 A1
(43) Pub. Date: Sep. 24, 2026

(54) Methods And Apparatus For Handover Candidate Determination In Mobile Communications

(71) Applicant: MediaTek Inc., Hsinchu City (TW)

(72) Inventors: Jen-Chien Liu, Hsinchu City (TW); Tsung-Ming Lee, Hsinchu City (TW); Keng-Ming Huang, Hsinchu City (TW); Chun-Fan Tsai, Hsinchu City (TW)

(73) Assignee: MediaTek Inc., Hsinchu City (TW)

(21) Appl. No.: 19/530,405

(22) Filed: Feb. 5, 2026

Related U.S. Application Data
(60) Provisional application No. 63/762,682, filed on Feb. 25, 2025.

(51) Int. Cl. H04W 36/00; H04W 24/10; H04W 36/30; H04W 36/36; H04W 74/0838

(52) U.S. Cl. CPC H04W 36/00835; H04W 24/10; H04W 36/304; H04W 36/362; H04W 74/0838

(57) ABSTRACT

Various solutions for handover candidate determination between a user equipment (UE) and a network node are described. The UE may determine at least one preferred network node. The UE may indicate the at least one preferred network node in a measurement report. The UE may transmit the measurement report to the network node. The network node may determine candidate network nodes for a conditional handover (CHO) procedure or a lower-layer triggered mobility (LTM) procedure based on the at least one preferred network node indicated in the measurement report. The network node may include the candidate network nodes in a radio resource control (RRC) reconfiguration. The network node may transmit the RRC reconfiguration to the UE.

### CROSS REFERENCE TO RELATED PATENT APPLICATIONS

The present disclosure is part of a non-provisional application claiming the priority benefits of U.S. Patent Application No. 63/762,682, filed on 25 Feb. 2025, the content of which herein being incorporated by reference in its entirety.

### TECHNICAL FIELD

The present disclosure is generally related to mobile communications and, more particularly, to the determination of candidate cells in conditional handover (CHO) or lower-layer triggered mobility (LTM) with respect to apparatus in mobile communications.

### BACKGROUND

Unless otherwise indicated herein, approaches described in this section are not prior art to the claims listed below and are not admitted as prior art by inclusion in this section.

In mobile communications, a source cell is responsible for identifying candidate cells for a CHO or an LTM procedure. And the candidate cells allocate resources to the user equipment (UE) in advance. The source cell may trigger CHO/LTM configurations after receiving a measurement report from the UE. The determination of the candidate cells may affect whether the CHO or the LTM is successful.

Accordingly, designing appropriate procedures for determining candidate cells in a new-generation communication system has become a critical issue in wireless communication systems, and there is an urgent need to provide such procedures to ensure efficient and reliable operation.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to the determination of CHO/LTM candidate cells with respect to apparatus in mobile communications.

In one aspect, a method may involve an apparatus determining at least one preferred network node. The method may also involve the apparatus indicating the at least one preferred network node in a measurement report. The method may further involve the apparatus transmitting the measurement report to a source network node.

In one aspect, a method may involve an apparatus receiving a measurement report from a user equipment (UE). The measurement report may indicate at least one preferred network node. The method may also involve the apparatus determining candidate network nodes for a conditional handover (CHO) procedure or a lower-layer triggered mobility (LTM) procedure according to the at least one preferred network node. The method may further involve the apparatus including the candidate network nodes in a radio resource control (RRC) reconfiguration. The method may further involve the apparatus transmitting the RRC reconfiguration to the UE.

In one aspect, an apparatus may comprise a transceiver which, during operation, wirelessly communicates with a network node. The apparatus may also comprise a processor communicatively coupled to the transceiver. The processor, during operation, may perform operations comprising determining at least one preferred network node. The processor may also perform operations comprising indicating the at least one preferred network node in a measurement report. The processor may further perform operations comprising transmitting, via the transceiver, the measurement report to a source network node.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting example scenarios under schemes in accordance with implementations of the present disclosure.

FIG. 2A is a diagram depicting an example scenario under schemes in accordance with implementations of the present disclosure.

FIG. 2B is a diagram depicting an example scenario under schemes in accordance with implementations of the present disclosure.

FIG. 3 is a diagram depicting an example scenario in accordance with implementations of the present disclosure.

FIG. 4 is a diagram depicting an example scenario in accordance with implementations of the present disclosure.

FIG. 5 is a diagram depicting an example process under schemes in accordance with implementations of the present disclosure.

FIG. 6 is a diagram depicting an example process under schemes in accordance with implementations of the present disclosure.

FIG. 7 is a block diagram of an example communication system in accordance with an implementation of the present disclosure.

FIG. 8 is a flowchart of an example process in accordance with an implementation of the present disclosure.

FIG. 9 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to the determination of candidate cells in CHO or LTM in mobile communications. According to the present disclosure, a number of possible solutions may be implemented separately or jointly. That is, although these possible solutions may be described below separately, two or more of these possible solutions may be implemented in one combination or another.

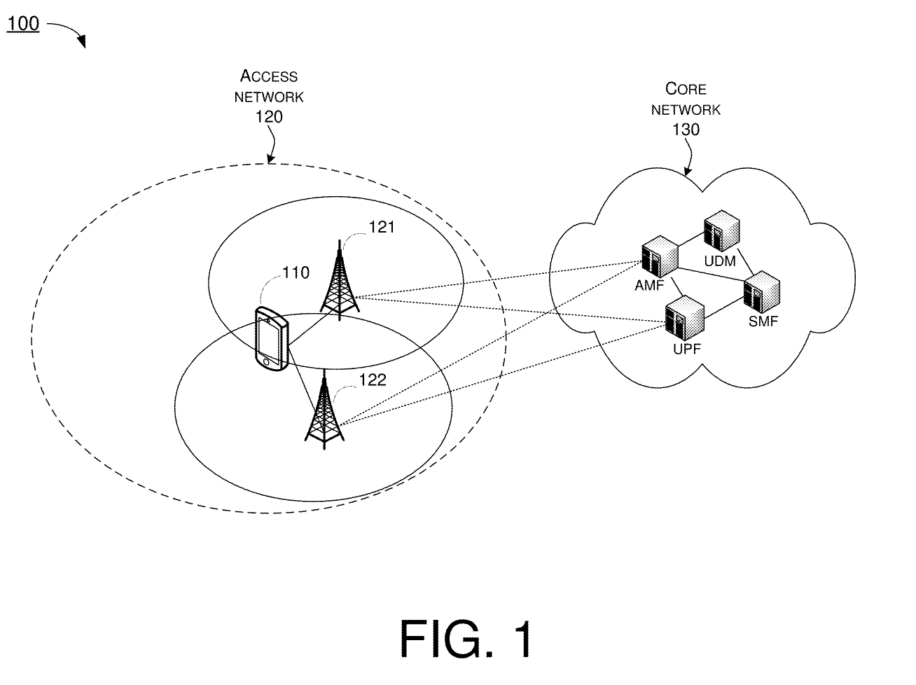

FIG. 1 illustrates an example scenario 100 of a communication environment in which various solutions and schemes in accordance with the present disclosure may be implemented. Scenario 100 involves a user equipment (UE) 110 in wireless communication with a wireless network (e.g., an LTE network, a 5G/NR network, an IoT network, or a 6G network) consisting of an access network 120 and a core network 130. The UE 110 may be a smart phone, a wearable device, an IoT device, and a tablet, etc. Alternatively, the UE 110 may be a notebook (NB) or personal computer (PC) inserted or installed with a data card which includes a modem and radio frequency (RF) transceiver(s) to provide the functionality of wireless communication. In one embodiment, the access network 120 is connected to the core network 130 by means of the NG interface, more specifically to a user plane function (UPF) by means of the NG user-plane part (NG-u), and to an access and mobility management function (AMF) by means of the NG control-plane part (NG-c). The access network 120 may include a network node 121 and a network node 122, which may be connected to multiple UPFs/AMFs respectively for the purpose of load sharing and redundancy. The network node may be called a base station (BS) or a cell. In addition, the core network may include other entities, such as a session management function (SMF) and a unified data management (UDM), etc. As illustrated, the access network 120 may include multiple BSs (e.g., network nodes 121, 122), each of which may provide communication coverage for a geographic coverage area where communications with the UE 110 are supported. The network node 121 may be a source cell or a source next-generation node B (gNB), and network node 122 may be a target cell or a target gNB. The UE 110 may operate in a Radio Resource Control IDLE (RRC_IDLE) mode, an RRC inactive (RRC_INACTIVE) mode, or an RRC_CONNECTED mode. The source network node (e.g., the network node 121) may perform a handover procedure (e.g., a CHO or an LTM procedure) with the UE 110 to exchange the connection to a target network node (e.g., the network node 122). For illustrative purposes, two network nodes (i.e., network nodes 121, 122) and one UE (UE 110) may be described hereinafter. However, it is not intended to limit the network scenarios of the present disclosure.

Mobility Robustness Optimization (MRO) procedure aims at detecting and enabling the correction of mobility problems. For analysis of connection failures, the UE makes the radio link failure (RLF) Report available to the network. The RAN node receiving the failure indication may inform the RAN node controlling the cell where the mobility configuration caused the failure. However, the source network node does not change the RRC reconfiguration for a CHO procedure or an LTM procedure based on the UE information response. The UE information response may include the RLF Report. The source network node may still configure worse CHO/LTM candidate cells in the RRC reconfiguration to the UE.

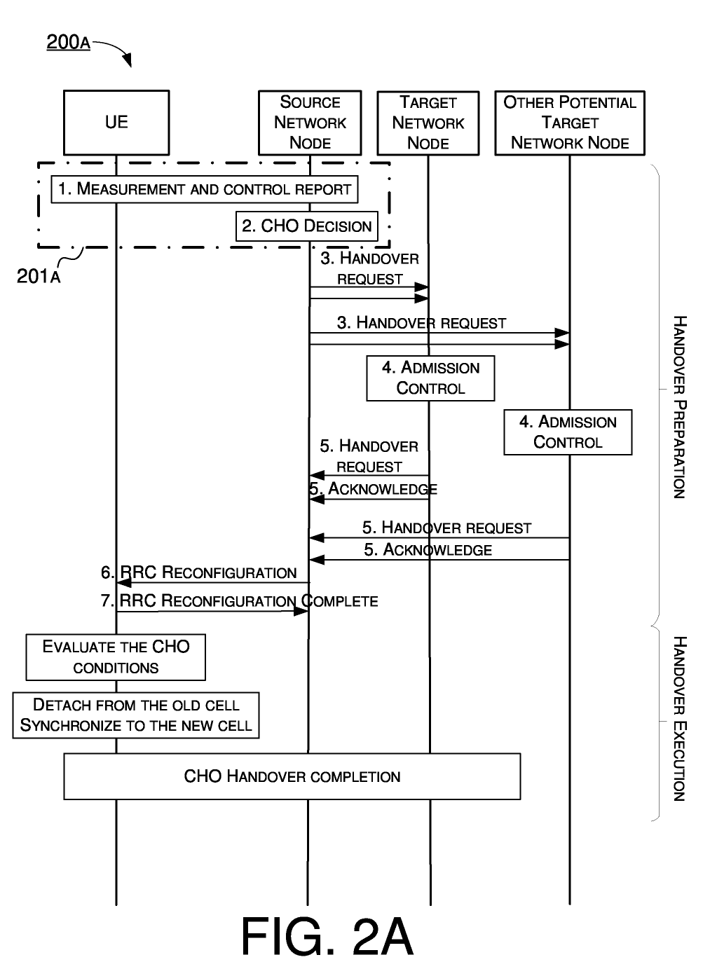

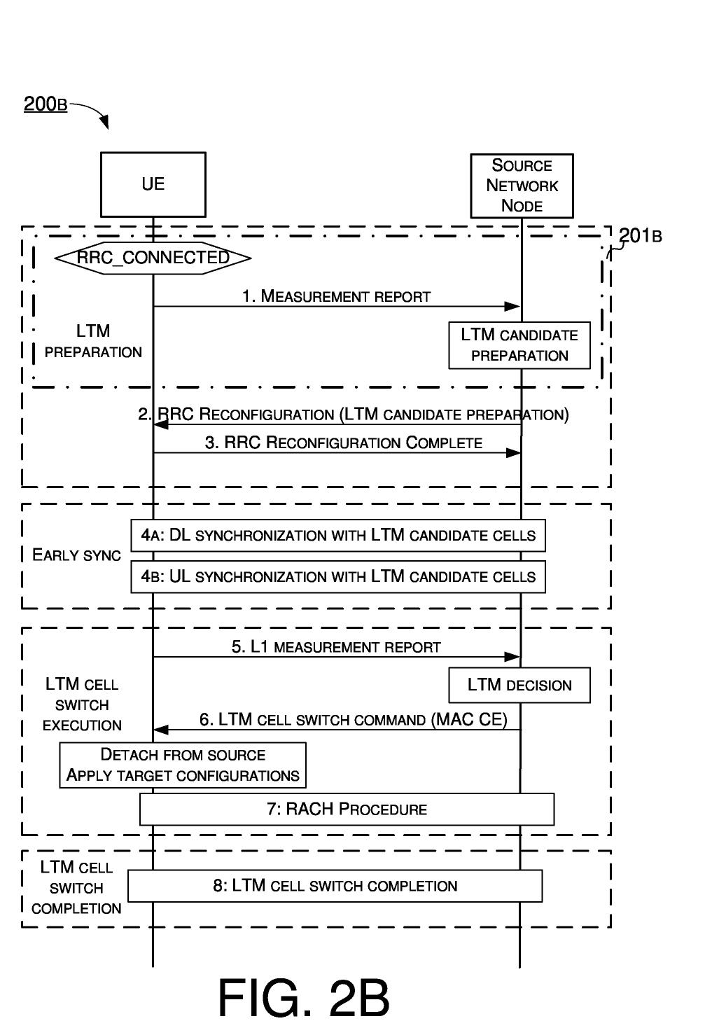

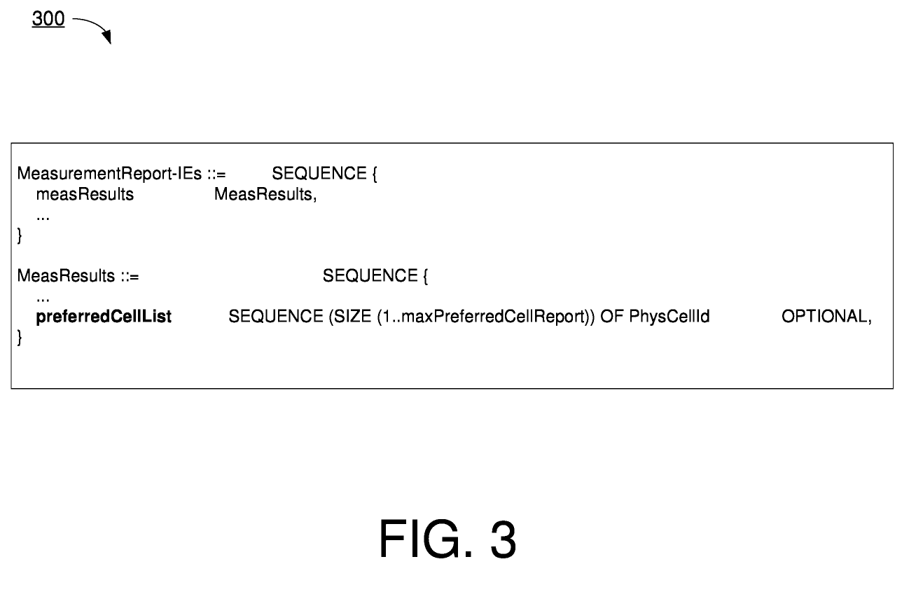

FIG. 2A is a diagram depicting an example scenario 200a of the determination of candidate cells in a CHO procedure in accordance with an implementation of the present disclosure. FIG. 2B is a diagram depicting an example scenario 200b of the determination of candidate cells in an LTM procedure in accordance with an implementation of the present disclosure. FIG. 3 is a diagram depicting an example scenario 300 of a measurement report message. In some embodiments, the UE may determine at least one preferred network node and indicate the at least one preferred network node (e.g., a preferred cell list such as preferredCellList shown in FIG. 3) in a measurement report. In one example, the at least one preferred network node may be determined from neighbor network nodes. In one example, the at least one preferred network node may be determined from measured network nodes. In one example, the at least one preferred network node may be determined from the measured network nodes and the neighbor network nodes. In one example, as shown in FIG. 2A, the UE may perform measurements and determine at least one preferred network node based on the measurement or UE information. Then the UE may indicate at least one preferred network node in the measurement report (e.g., 201a shown in FIG. 2A) during a handover preparation stage of a CHO procedure. After that, the UE transmits the measurement report indicating the preferred network node to the source network node (e.g., the source gNB) if a report criterion is satisfied. In one example, as shown in FIG. 2B, the UE is in an RRC_CONNECTED mode and may indicate at least one preferred network node in a measurement report (e.g., 201b shown in FIG. 2B) during an LTM preparation stage of an LTM procedure. Accordingly, the UE indicates the preferred candidate cell(s) to the network, allowing the network to make proper determinations regarding the CHO/LTM candidates. In addition, the UE may contribute to the handover decision without maintaining configurations across multiple cells, enabling the network to make more accurate decisions on CHO/LTM candidate cells.

In some embodiments, the UE may determine at least one preferred network node based on UE information. In one embodiment, the UE may determine the at least one preferred network node based on a historical trajectory (e.g., regular transportation routes) of neighboring network nodes or measured network nodes. In one embodiment, the UE may predict at least one preferred network node using an artificial intelligence (AI) or machine learning (ML) model based on signal characteristics of neighboring or measured network nodes. The signal characteristics may be signal strength variance of neighboring network nodes or measured network nodes, reference signal received power (RSRP) of neighboring network nodes or measured network nodes, reference signal received quality (RSRQ) of neighboring network nodes or measured network nodes, signal to interference plus noise ratio (SINR) of neighboring network nodes or measured network nodes, signal quality variance of neighboring network nodes or measured network nodes, etc.

In some embodiments, the network node (i.e., the source network node) may receive the measurement report from the UE. The source network node may determine candidate network nodes for a CHO procedure or an LTM procedure (i.e., CHO/LTM candidate cells), referring to the indicated preferred cell in the measurement report. In one embodiment, the source network node may reduce the number of CHO/LTM candidate cells (e.g., reduce from 8 to 1 or 2) after receiving the measurement report. Then the source network node may include the CHO/LTM candidate cells in an RRC reconfiguration and transmit the RRC reconfiguration to the UE. Accordingly, the source network node may configure fewer candidate network nodes to the UE via the measurement report.

In some embodiments, the UE may receive the RRC reconfiguration from the source network node in response to transmitting the measurement report. The RRC reconfiguration may indicate candidate network nodes for the CHO procedure or the LTM procedure. The candidate network nodes may include a preferred cell list.

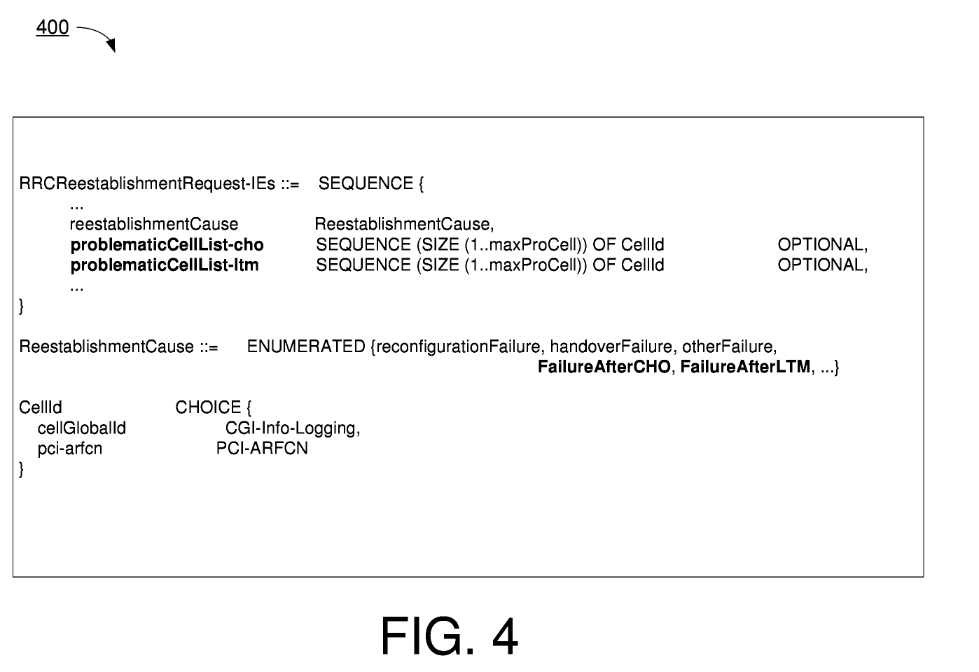

FIG. 4 is a diagram depicting an example scenario 400 of an RRC reestablishment request message. In some embodiments, the UE may perform the CHO procedure in a case that CHO conditions are met or perform the LTM procedure after receiving an LTM cell switch command from the source cell. The UE may determine whether a target network node is problematic after the UE switches to the target cell. In some cases, the UE may determine the target cell as the problematic cell in an event that a condition is met. Then the UE may indicate or include the problematic CHO/LTM candidate list (e.g., problematicCellList-cho, problematicCellList-ltm shown in FIG. 4) in an RRC reestablishment request message and transmit the RRC reestablishment request message to the network (e.g., source network node). Accordingly, the network may avoid configuring the problematic network node for the UE, thereby reducing latency and improving mobility robustness.

In one embodiment, the UE may use a contention-free random access (CFRA) resource to perform random access after the CHO procedure or the LTM procedure is triggered by the source network node (i.e., after cell switch). In this case, the UE may determine that the CFRA has failed in an event that the UE does not receive a random-access response (RAR) from the network (e.g., the target cell). The UE may record the target network node as the problematic network node in an event that the CFRA has failed. In this case, the condition may include that the CFRA has failed.

In one embodiment, the UE may monitor a physical downlink control channel (PDCCH) on the target network node after the CHO procedure or the LTM procedure is triggered by the source network node (i.e., after cell switch). In this case, the UE may determine whether there is a downlink or uplink resource assignment on the PDCCH. The UE may record the target network node as the problematic network node in an event that there is no downlink or uplink resource assignment on the PDCCH. In one embodiment, the UE may further set, include or indicate a cause with a new reason (e.g., FailureAfterCHO, FailureAfterLTM shown in FIG. 4) in the RRC reestablishment request message in an event that there is no downlink or uplink resource assignment on the PDCCH after cell switch and perform the RRC reestablishment procedure. In this case, the condition may include that there is no downlink or uplink resource assignment on the PDCCH.

The source network node may receive the RRC reestablishment request message from the UE. The RRC reestablishment request message may indicate the problematic network node. After the RRC reestablishment is successful, the source network node may determine CHO/LTM candidate cells and exclude the problematic network node from the CHO/LTM candidate cells based on the RRC reestablishment request message. Next time, the source network may include the CHO/LTM candidate cells in the RRC reconfiguration during a preparation stage of the CHO or LTM procedure. At this time, the source network may not include the problematic network node in the RRC reconfiguration (i.e., not configure the problematic network node as a CHO/LTM candidate for the UE) after receiving the measurement report.

In the present disclosure, the UE may indicate the preferred candidate cell(s) and/or problematic cell(s) to the network, allowing the network to make proper determinations regarding the CHO/LTM candidates. Accordingly, the UE may contribute to the handover decision without maintaining configurations across multiple cells, enabling the network to make more accurate decisions on CHO/LTM candidate cells. In addition, the UE may reduce latency and improve mobility robustness by avoiding problematic cells.

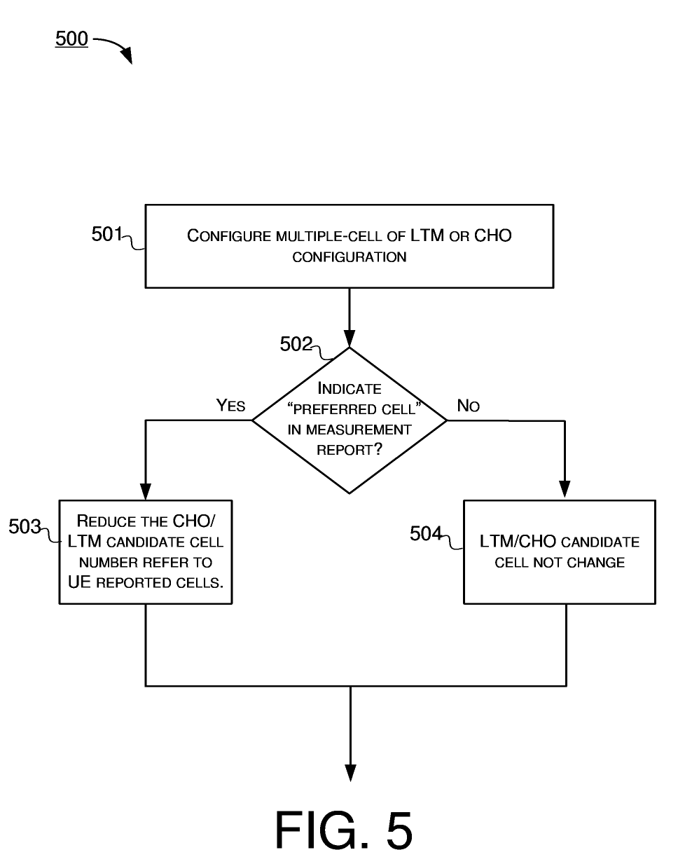

FIG. 5 is a diagram depicting an example process 500 of the determination of candidate cells in a CHO procedure or an LTM procedure in accordance with an implementation of the present disclosure. The process 500 may proceed from step 501 to step 504.

In step 501, the NW (e.g., the source gNB) may configure multiple candidate cells of LTM or CHO configuration. Then the process proceeds to step 502.

In step 502, the NW (e.g., the source gNB) may determine whether the UE indicates a preferred cell list in a measurement report. If yes, the process proceeds to step 503; otherwise, to step 504.

In step 503, the NW (e.g., the source gNB) may determine CHO/LTM candidate cells based on the preferred cell list. The number of the CHO/LTM candidate cells may be reduced as a result. In step 504, the NW (e.g., the source gNB) may remain the CHO/LTM candidate cells unchanged.

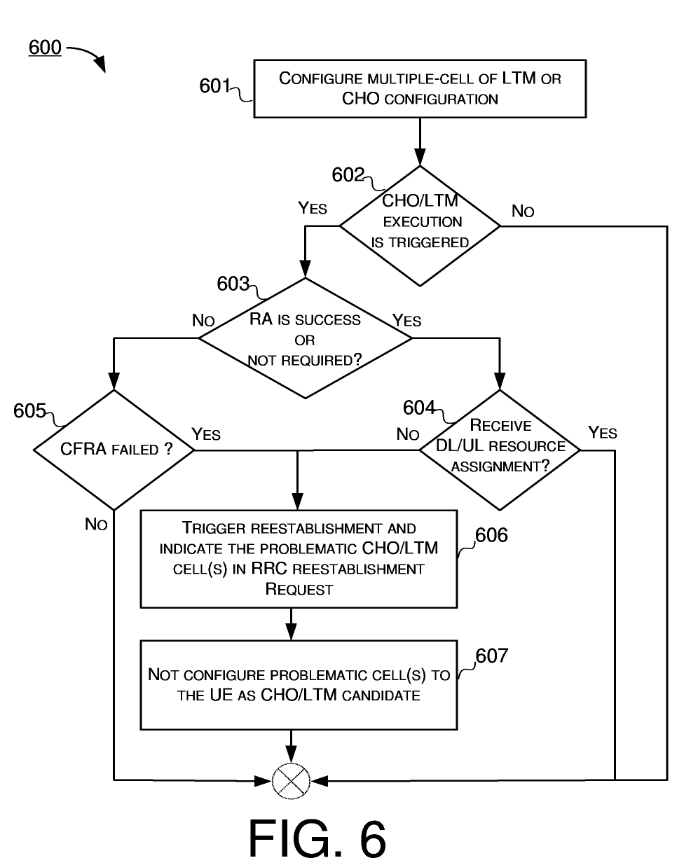

FIG. 6 is a diagram depicting an example process 600 of the determination of candidate cells in a CHO procedure or an LTM procedure in accordance with an implementation of the present disclosure. The process 600 may proceed from step 601 to step 607.

In step 601, the NW (e.g., the source gNB) may configure multiple candidate cells of LTM or CHO configuration. Then the process proceeds to step 602. In step 602, the NW (e.g., the source gNB) may determine whether the LTM or CHO procedure is triggered. If yes, the process proceeds to step 603; otherwise, the process 600 ends.

In step 603, the UE may determine whether a random access is successful (for random access channel (RACH)-based handover) or a random access is not required (for random access channel (RACH)-less handover). If yes, the process proceeds to step 604; otherwise, to step 605.

In step 604, the UE may determine whether there is a downlink or uplink resource assignment on the PDCCH. If no, the process proceeds to step 606; otherwise, the process 600 ends.

In step 605, the UE may determine whether a CFRA has failed. If yes, the process proceeds to step 606; otherwise, the process 600 ends.

In step 606, the UE may trigger a reestablishment procedure and indicate a problematic CHO/LTM cell in an RRC reestablishment request. Then the process proceeds to step 607.

In step 607, the NW (e.g., the source gNB) may not configure the problematic CHO/LTM cell to the UE as a CHO/LTM candidate.

### Illustrative Implementations

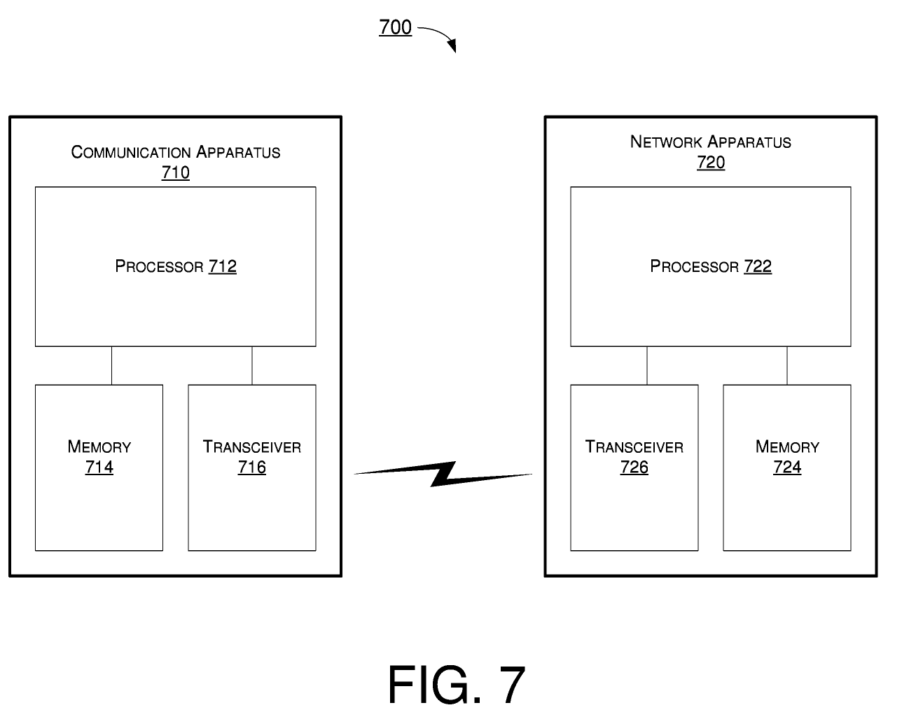

FIG. 7 illustrates an example communication system 700 having an example communication apparatus 710 and an example network apparatus 720 in accordance with an implementation of the present disclosure. Each of communication apparatus 710 and network apparatus 720 may perform various functions to implement schemes, techniques, processes and methods described herein pertaining to improving the determination of CHO/LTM candidate cells with respect to UE and network apparatus in mobile communications, including scenarios/schemes described above as well as processes 800 and 900 described below.

Communication apparatus 710 may be a part of an electronic apparatus, which may be a UE such as a portable or mobile apparatus, a wearable apparatus, a wireless communication apparatus or a computing apparatus. For instance, communication apparatus 710 may be implemented in a smartphone, a smartwatch, a personal digital assistant, a digital camera, or a computing equipment such as a tablet computer, a laptop computer or a notebook computer. Communication apparatus 710 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 710 may be implemented in a smart thermostat, a smart fridge, a smart door lock, a wireless speaker or a home control center. Alternatively, communication apparatus 710 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 710 may include at least some of those components shown in FIG. 7 such as a processor 712, for example. Communication apparatus 710 may further include one or more other components not pertinent to the proposed scheme of the present disclosure (e.g., internal power supply, display device and/or user interface device), and, thus, such component(s) of communication apparatus 710 are neither shown in FIG. 7 nor described below in the interest of simplicity and brevity.

Network apparatus 720 may be a part of a network apparatus, which may be a network node such as a satellite, a base station, a small cell, a router or a gateway. For instance, network apparatus 720 may be implemented in an eNodeB in an LTE network, in a gNB in a 5G/NR, IoT, NB-IoT or IIoT network or in a satellite or base station in a 6G network. Alternatively, network apparatus 720 may be implemented in the form of one or more IC chips such as, for example and without limitation, one or more single-core processors, one or more multi-core processors, or one or more RISC or CISC processors. Network apparatus 720 may include at least some of those components shown in FIG. 7 such as a processor 722, for example. Network apparatus 720 may further include one or more other components not pertinent to the proposed scheme of the present disclosure (e.g., internal power supply, display device and/or user interface device), and, thus, such component(s) of network apparatus 720 are neither shown in FIG. 7 nor described below in the interest of simplicity and brevity.

In one aspect, each of processor 712 and processor 722 may be implemented in the form of one or more single-core processors, one or more multi-core processors, or one or more CISC processors. That is, even though a singular term “a processor” is used herein to refer to processor 712 and processor 722, each of processor 712 and processor 722 may include multiple processors in some implementations and a single processor in other implementations in accordance with the present disclosure. In another aspect, each of processor 712 and processor 722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 712 and processor 722 is a special-purpose machine specifically designed, arranged and configured to perform specific tasks including improving the determination of CHO/LTM candidate cells in a device (e.g., as represented by communication apparatus 710) and a network (e.g., as represented by network apparatus 720) in accordance with various implementations of the present disclosure.

In some implementations, communication apparatus 710 may also include a transceiver 716 coupled to processor 712 and capable of wirelessly transmitting and receiving data. In other words, processor 712 may transceive the data such as configuration, message, signal, information, indicator, etc. via transceiver 716. Transceiver 716 may include an MR and an LR. In some implementations, communication apparatus 710 may further include a memory 714 coupled to processor 712 and capable of being accessed by processor 712 and storing data therein. In some implementations, network apparatus 720 may also include a transceiver 726 coupled to processor 722 and capable of wirelessly transmitting and receiving data. In other words, processor 722 may transceive the data such as configuration, message, signal, information, indicator, etc. via transceiver 726. In some implementations, network apparatus 620 may further include a memory 724 coupled to processor 722 and capable of being accessed by processor 722 and storing data therein. Accordingly, communication apparatus 710 and network apparatus 720 may wirelessly communicate with each other via transceiver 716 and transceiver 726, respectively. To aid better understanding, the following description of the operations, functionalities and capabilities of each of communication apparatus 710 and network apparatus 720 is provided in the context of a mobile communication environment in which communication apparatus 710 is implemented in or as a communication apparatus or a UE and network apparatus 720 is implemented in or as a network node of a communication network.

In some implementations, each of memory 714 and memory 724 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 614 and memory 724 may include a type of read-only memory (ROM) such as mask ROM, programmable ROM (PROM), erasable programmable ROM (EPROM) and/or electrically erasable programmable ROM (EEPROM). Alternatively, or additionally, each of memory 714 and memory 724 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

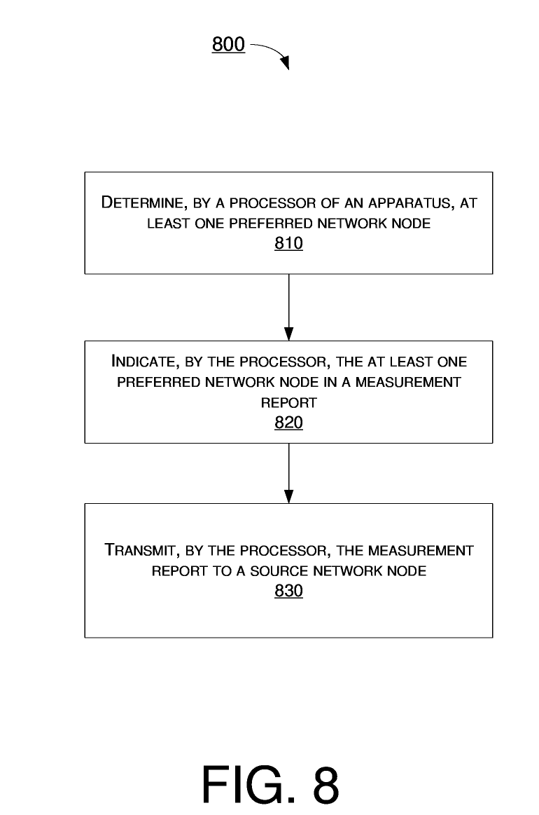

FIG. 8 illustrates an example process 800 in accordance with an implementation of the present disclosure. Process 800 may be an example implementation of above scenarios/schemes, whether partially or completely, with respect to improving the determination of CHO/LTM candidate cells of the present disclosure. Process 800 may represent an aspect of implementation of features of communication apparatus 710. Process 800 may include one or more operations, actions, or functions as illustrated by one or more of blocks 810 to 830. Although illustrated as discrete blocks, various blocks of process 800 may be divided into additional blocks, combined into fewer blocks, or eliminated, depending on the desired implementation. Moreover, the blocks of process 800 may be executed in the order shown in FIG. 8 or, alternatively, in a different order. Process 800 may be implemented by communication apparatus 710 or any suitable UE or machine type devices. Solely for illustrative purposes and without limitation, process 800 is described below in the context of communication apparatus 710. Process 800 may begin at block 810.

At block 810, process 800 may involve processor 712 of communication apparatus 710 determining at least one preferred network node. Process 800 may proceed from block 810 to block 820.

At block 820, process 800 may involve processor 712 of communication apparatus 710 indicating the at least one preferred network node in a measurement report. Process 700 may proceed from block 820 to block 830.

At block 830, process 800 may involve processor 712 of communication apparatus 710 transmitting the measurement report to a source network node. The network apparatus 720 may be the source network node.

In some implementations, process 800 may involve processor 712 of communication apparatus 710 receiving an RRC reconfiguration from the source network node in response to transmitting the measurement report.

In some implementations, the RRC reconfiguration indicates candidate network nodes for a CHO procedure or an LTM procedure. The candidate network nodes may comprise the at least one preferred network node.

In some implementations, the at least one preferred network node is determined based on a historical trajectory of neighboring network nodes or measured network nodes.

In some implementations, process 800 may involve processor 712 of communication apparatus 710 predicting the at least one preferred network node by an AI model or an ML model based on signal strength variance of neighboring network nodes or measured network nodes.

In some implementations, process 800 may involve processor 712 of communication apparatus 710 performing a CHO procedure or an LTM procedure. The process 800 may also involve processor 712 of communication apparatus 710 determining a target network node as a problematic network node in an event that a condition is met. The process 800 may further involve processor 712 of communication apparatus 710 indicating the problematic network node in an RRC reestablishment request message. The process 800 may further involve processor 712 of communication apparatus 710 transmitting, the RRC reestablishment request message.

In some implementations, process 800 may involve processor 712 of communication apparatus 710 performing a CFRA after triggering the CHO procedure or the LTM procedure. The process 800 may also involve processor 712 of communication apparatus 710 determining whether the CFRA has failed. The condition may include that the CFRA has failed.

In some implementations, process 800 may involve processor 712 of communication apparatus 710 monitoring a PDCCH on the target network node after triggering the CHO procedure or the LTM procedure. The process 800 may also involve processor 712 of communication apparatus 710 determining whether there is a downlink or uplink resource assignment on the PDCCH. The condition may include that there is no downlink or uplink resource assignment on the PDCCH.

In some implementations, process 800 may involve processor 712 of communication apparatus 710 indicating a cause in the RRC reestablishment request message in an event that there is no downlink or uplink resource assignment on the PDCCH.

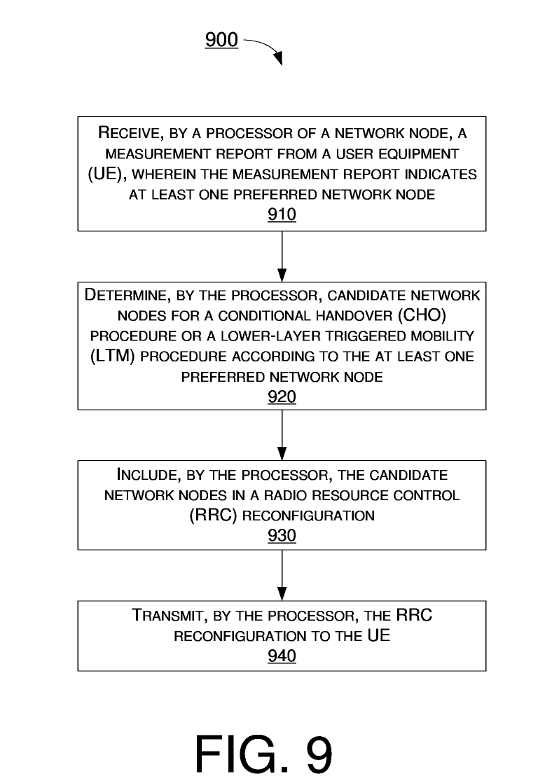

FIG. 9 illustrates an example process 900 in accordance with an implementation of the present disclosure. Process 900 may be an example implementation of above scenarios/schemes, whether partially or completely, with respect to improving the determination of CHO/LTM candidate cells of the present disclosure. Process 900 may represent an aspect of implementation of features of network apparatus 720. Process 900 may include one or more operations, actions, or functions as illustrated by one or more of blocks 910 to 940. Although illustrated as discrete blocks, various blocks of process 900 may be divided into additional blocks, combined into fewer blocks, or eliminated, depending on the desired implementation. Moreover, the blocks of process 900 may be executed in the order shown in FIG. 9 or, alternatively, in a different order. Process 900 may be implemented by network apparatus 720 or any suitable network device or machine type devices. Solely for illustrative purposes and without limitation, process 900 is described below in the context of network apparatus 720. Process 900 may begin at block 910.

At block 910, process 900 may involve processor 722 of network apparatus 720 receiving a measurement report from communication apparatus 710. The measurement report may indicate at least one preferred network node. Process 900 may proceed from block 910 to block 920.

At block 920, process 900 may involve processor 722 of network apparatus 720 determining candidate network nodes for a CHO procedure or an LTM procedure according to the at least one preferred network node. Process 900 may proceed from block 920 to block 930.

At block 930, process 900 may involve processor 722 of network apparatus 720 including the candidate network nodes in an RRC reconfiguration. Process 900 may proceed from block 930 to block 940.

At block 940, process 900 may involve processor 722 of network apparatus 720 transmitting the RRC reconfiguration to communication apparatus 710.

In some implementations, process 900 may involve processor 722 of network apparatus 720 reducing a number of candidate network nodes after receiving the measurement report.

In some implementations, process 900 may involve processor 722 of network apparatus 720 receiving an RRC reestablishment request message from communication apparatus 710. The RRC reestablishment request message may indicate a problematic network node. The process 900 may further involve processor 722 of network apparatus 720 excluding the problematic network node from the candidate network nodes.

In some implementations, the RRC reestablishment request message further comprises a cause indicating that there is no downlink or uplink resource assignment received by communication apparatus 710.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively "associated" such that the desired functionality is achieved. Hence, any two components herein combined to achieve a particular functionality can be seen as "associated with" each other such that the desired functionality is achieved, irrespective of architectures or intermedial components. Likewise, any two components so associated can also be viewed as being "operably connected", or "operably coupled", to each other to achieve the desired functionality, and any two components capable of being so associated can also be viewed as being "operably couplable", to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to implementations containing only one such recitation, even when the same claim includes the introductory phrases "one or more" or "at least one" and indefinite articles such as "a" or "an," e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of "two recitations," without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, at least one preferred network node;
indicating, by the processor, the at least one preferred network node in a measurement report; and
transmitting, by the processor, the measurement report to a source network node.

2. The method of claim 1, further comprising:
receiving, by the processor, a radio resource control (RRC) reconfiguration from the source network node in response to transmitting the measurement report.

3. The method of claim 2, wherein the RRC reconfiguration indicates candidate network nodes for a conditional handover (CHO) procedure or a lower-layer triggered mobility (LTM) procedure, and wherein the candidate network nodes comprise the at least one preferred network node.

4. The method of claim 1, wherein the at least one preferred network node is determined based on a historical trajectory of neighboring network nodes or measured network nodes.

5. The method of claim 1, wherein the determining of the at least one preferred network node further comprises:
predicting, by the processor, the at least one preferred network node by an artificial intelligence (AI) model or a machine learning (ML) model based on signal strength variance of neighboring network nodes or measured network nodes.

6. The method of claim 1, further comprising:
performing, by the processor, a conditional handover (CHO) procedure or a lower-layer triggered mobility (LTM) procedure;
determining, by the processor, a target network node as a problematic network node in an event that a condition is met;
indicating, by the processor, the problematic network node in a radio resource control (RRC) reestablishment request message; and
transmitting, by the processor, the RRC reestablishment request message.

7. The method of claim 6, further comprising:
performing, by the processor, a contention-free random access (CFRA) after triggering the CHO procedure or the LTM procedure; and
determining, by the processor, whether the CFRA has failed, wherein the condition comprises that the CFRA has failed.

8. The method of claim 6, further comprising:
monitoring, by the processor, a physical downlink control channel (PDCCH) on the target network node after triggering the CHO procedure or the LTM procedure; and
determining, by the processor, whether there is a downlink or uplink resource assignment on the PDCCH, wherein the condition comprises that there is no downlink or uplink resource assignment on the PDCCH.

9. The method of claim 8, further comprising:
indicating, by the processor, a cause in the RRC reestablishment request message in an event that there is no downlink or uplink resource assignment on the PDCCH.

10. A method, comprising:
receiving, by a processor of a network node, a measurement report from a user equipment (UE), wherein the measurement report indicates at least one preferred network node;
determining, by the processor, candidate network nodes for a conditional handover (CHO) procedure or a lower-layer triggered mobility (LTM) procedure according to the at least one preferred network node;
including, by the processor, the candidate network nodes in a radio resource control (RRC) reconfiguration; and
transmitting, by the processor, the RRC reconfiguration to the UE.

11. The method of claim 10, further comprising:
reducing, by the processor, a number of candidate network nodes after receiving the measurement report.

12. The method of claim 10, further comprising:
receiving, by the processor, an RRC reestablishment request message from the UE, wherein the RRC reestablishment request message indicates a problematic network node, wherein the determining of the candidate network nodes further comprises:
excluding, by the processor, the problematic network node from the candidate network nodes.

13. The method of claim 12, wherein the RRC reestablishment request message further comprises a cause indicating that there is no downlink or uplink resource assignment received by the UE.

14. An apparatus, comprising:
a transceiver, during operation, wirelessly communicates with a wireless network; and
a processor communicatively coupled to the transceiver such that, during operation, the processor performs operations comprising:
determining at least one preferred network node;
indicating the at least one preferred network node in a measurement report; and
transmitting, via the transceiver, the measurement report to a source network node.

15. The apparatus of claim 14, wherein the processor is further configured to perform operations comprising:
receiving, via the transceiver, a radio resource control (RRC) reconfiguration from the source network node in response to transmitting the measurement report.

16. The apparatus of claim 14, wherein the at least one preferred network node is determined based on a historical trajectory of neighboring network nodes or measured network nodes.

17. The apparatus of claim 14, wherein the processor is further configured to perform operations comprising:
predicting the at least one preferred network node by an artificial intelligence (AI) model or a machine learning (ML) model based on signal strength variance of neighboring network nodes or measured network nodes.

18. The apparatus of claim 14, wherein the processor is further configured to perform operations comprising:
performing a conditional handover (CHO) procedure or a lower-layer triggered mobility (LTM) procedure;
determining a target network node as a problematic network node in an event that a condition is met;
indicating the problematic network node in a radio resource control (RRC) reestablishment request message; and
transmitting, via the transceiver of the apparatus, the RRC reestablishment request message.

19. The apparatus of claim 18, wherein the processor is further configured to perform operations comprising:
performing a contention-free random access (CFRA) after performing the CHO procedure or the LTM procedure; and
determining whether the CFRA has failed, wherein the condition comprises the CFRA has failed.

20. The apparatus of claim 18, wherein the processor is further configured to perform operations comprising:
monitoring a physical downlink control channel (PDCCH) on the target network node after triggering the CHO procedure or the LTM procedure; and
determining whether there is a downlink or uplink resource assignment on the PDCCH, wherein the condition comprises that there is no downlink or uplink resource assignment on the PDCCH.
